(19) United States
(12) Patent Application Publication
(10) Pub. No.: US 2009/0323215 A1
(43) Pub. Date: Dec. 31, 2009

(54) HEAD POSITION CONTROL DEVICE, MAGNETIC DISK DEVICE, AND HEAD POSITION CONTROL METHOD

(75) Inventor: Katsuki UEDA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/364,323

(22) Filed: Feb. 2, 2009

(30) Foreign Application Priority Data
Jun. 30, 2008 (JP) 2008-171591

(51) Int. Cl. G11B 21/02

(52) U.S. Cl. 360/75

(57) ABSTRACT

According to one embodiment, a head position control device includes a positioning controller, a sensor, and a storage module. The positioning controller outputs, to a head moving mechanism that moves a head in the radial direction of a magnetic disk, a control signal indicating a position to which the head is to be moved. The sensor detects the environmental temperature around the magnetic disk. The storage module stores expected temperatures each associated with a filter coefficient of a filter that attenuates specific frequency components of the control signal. The positioning controller creates a filter based on filter coefficients associated with two values of the expected temperatures close to the environmental temperature, and applies the filter to the control signal.

### CROSS-REFERENCE TO RELATED APPLICATIONS

This application is based upon and claims the benefit of priority from Japanese Patent Application No. 2008-171591, filed Jun. 30, 2008, the entire contents of which are incorporated herein by reference.

### BACKGROUND

1. Field

One embodiment of the invention relates to a head position control device that positions a head on a magnetic disk, a magnetic disk device, and a head position control method.

2. Description of the Related Art

Conventional magnetic disk devices generally include a digital control system using a microcomputer as a head positioning control system. In such a magnetic disk device, a microprocessor calculates a control command based on the position information of its head discretely obtained, and issues the control command to an actuator driver through a D/A converter.

Typically, the head positioning control system of a magnetic disk adjusts the amount of current flowing through a voice coil motor (VCM) to position the head attached to the end of an actuator. Since the actuator has a mechanical resonance mode, the head positioning control system comprises, in addition to a stabilizing compensator that stabilizes frequency characteristics, a notch filter used to suppress the resonance of the actuator to attenuate a specific frequency of a VCM control signal.

In the resonance mode, frequency-gain characteristics sometimes vary depending on the temperature. To overcome the characteristic variation in the resonance mode, the depth of the resonance and the width of its specific frequency attenuated by the notch filter may be set to values that enables the entire range of temperature variation to be covered. However, there is a trade-off that as the depth of the resonance and the width of its frequency increase, the phase around the bandwidth frequency degrades and thus the positioning accuracy decreases. In view of this, a conventional technology has been proposed in which the range over which the temperature varies is divided into predetermined temperature ranges, and each range is stored in a table in association with a cutoff frequency. When the environmental temperature changes to a different value, this table allows the use of a notch filter having a cutoff frequency associated with a temperature range corresponding to the value, thereby improving the positioning accuracy (see, for example, Japanese Patent Application Publication (KOKAI) No. 2001-195849).

Meanwhile, due to an increase in TPI (track per inch) along with an increase in recording density and capacity of the magnetic disk, the head positioning control system is required to achieve more accurate positioning. With the above conventional technology, the temperature ranges stored in the table need to be refined, i.e., narrowed, further to improve the positioning accuracy. This increases the amount of data and thus necessitates a higher capacity storage device to store the table, resulting in higher costs. If the temperature ranges are broadened, a cutoff frequency stored in the table may fail to match the one suitable for the environmental temperature. Accordingly, the positioning accuracy decreases.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a hard disk drive device according to an embodiment of the invention;

FIG. 2 is an exemplary diagram of a coefficient table stored in a storage module illustrated in FIG. 1 in the embodiment;

FIG. 3 is an exemplary flowchart of a notch filter creation process in the embodiment; and

FIG. 4 is an exemplary graph of characteristics of a notch filter created by the notch filter creation process in the embodiment.

### DETAILED DESCRIPTION

Various embodiments according to the invention will be described hereinafter with reference to the accompanying drawings. In general, according to one embodiment of the invention, a head position control device comprises: a positioning controller configured to output, to a head moving mechanism that moves a head to scan a magnetic disk in a radial direction of the magnetic disk, a control signal indicating a position to which the head is to be moved; a sensor configured to detect environmental temperature around the magnetic disk; and a storage module configured to store expected temperatures at intervals of predetermined degrees, each associated with a filter coefficient of a filter that attenuates a specific frequency component of a control signal corresponding to the expected temperature. The positioning controller creates, based on a rate corresponding to a difference between the environmental temperature detected by the sensor and two values of the expected temperatures close to the environmental temperature, a filter using filter coefficients associated with the two values, and applies the filter to the control signal.

According to another embodiment of the invention, a magnetic disk device comprises: a head configured to read data from and write data to a magnetic disk; a head moving mechanism configured to move the head in a radial direction of the magnetic disk; a positioning controller configured to output a control signal to the head moving mechanism to position the head at a desired location on the magnetic disk; a sensor configured to detect environmental temperature around the magnetic disk; and a storage module configured to store expected temperatures at intervals of predetermined degrees, each associated with a filter coefficient of a filter that attenuates a specific frequency component of a control signal corresponding to the expected temperature. The positioning controller creates, based on a rate corresponding to a difference between the environmental temperature detected by the sensor and two values of the expected temperatures close to the environmental temperature, a filter using filter coefficients associated with the two values, and applies the filter to the control signal.

According to still another embodiment of the invention, a head position control method applied to a head position control device configured to output, to a head moving mechanism that moves a head to scan a magnetic disk in a radial direction of the magnetic disk, a control signal indicating a position to which the head is to be moved, the head position control device including a storage module that stores expected temperatures at intervals of predetermined degrees, each associated with a filter coefficient of a filter that attenuates a specific frequency component of a control signal corresponding to the expected temperature, comprises: detecting environmental temperature around the magnetic disk; and creating, based on a rate corresponding to a difference between the environmental temperature detected at the detecting and two values of the expected temperatures close to the environmental temperature, a filter using filter coefficients associated with the two values to apply the filter to the control signal.

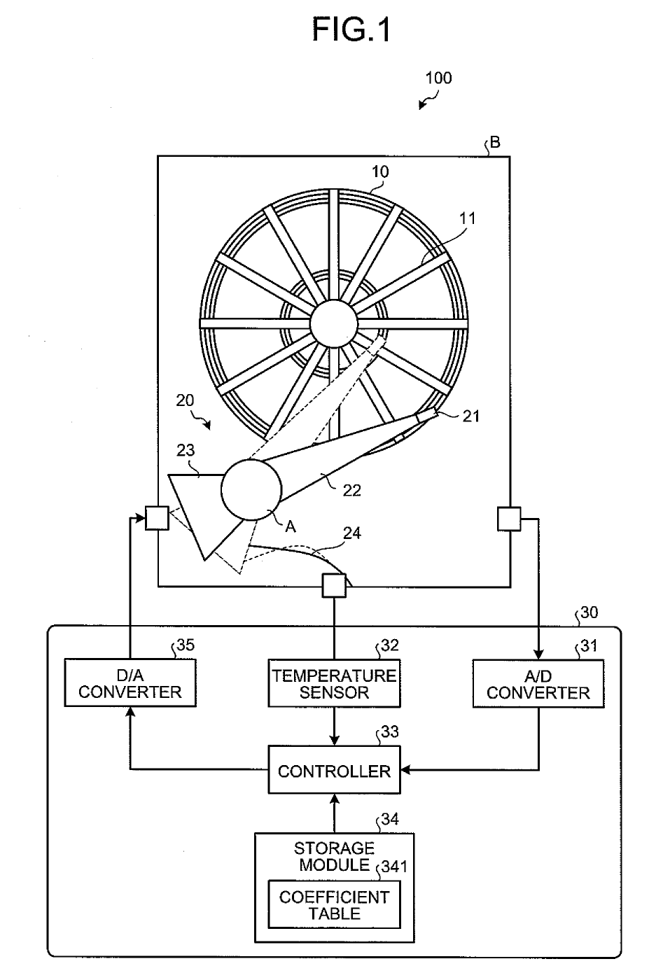

FIG. 1 is a block diagram of a hard disk drive device 100 according to an embodiment of the invention. As illustrated in FIG. 1, the hard disk drive device 100 comprises at least one hard disk 10, an actuator 20, and a hard disk drive (HDD) controller 30. The hard disk 10 is mounted on a base B. The actuator 20 comprises such mechanisms as a magnetic head 21, an arm 22, a voice coil motor (VCM) 23, and a flexible printed circuit board 24. The HDD controller 30 is provided as a control circuit that has a head positioning control mechanism on a printed circuit board inside the hard disk drive device 100.

The one or more hard disks 10 rotate at high speed, driven by a spindle motor (not shown) On the hard disk 10, servo data are written magnetically from the center of the hard disk 10 in the radial direction to form radial servo sectors 11. The position information of tracks is previously written to the servo sectors 11. A data sector lies between two adjacent servo sectors to store data.

In the actuator 20, as illustrated in FIG. 1, the magnetic head 21 is attached to the arm 22. The magnetic head 21 reads the position information of tracks from the servo sectors 11 as well as reading data from and writing data to the data sectors. By the driving force of the VCM 23, the arm 22 rotates about an axis A to move the magnetic head 21 in the radial direction of the hard disk 10. The VCM 23 comprises a magnet and a driving coil (not shown) and is driven by a drive current supplied from a D/A converter 35, which will be described later. The flexible printed circuit board 24 is fixed in such a manner as to connect the actuator 20 and the control circuit through the base B of the hard disk 10, and is used for exchange of data such as data read from the hard disk 10 and data to be written to the hard disk 10.

The HDD controller 30 comprises, as illustrated in FIG. 1, an A/D converter 31, a temperature sensor 32, a controller 33, a storage module 34, and the D/A converter 35.

The A/D converter 31 performs A/D conversion of the position information of tracks read by the magnetic head 21 from the servo sectors 11, i.e., the position information of the magnetic head 21, and outputs it to the controller 33.

The temperature sensor 32 is a thermistor, and detects the temperature of the hard disk drive device 100 at regular intervals. The temperature sensor 32 outputs this temperature to the controller 33 as the environmental temperature of the hard disk drive device 100. The temperature sensor 32 is described herein, by way of example and without limitation, as being located on the printed circuit board.

The controller 33 is a microprocessor that performs various operations of the head positioning control system of the embodiment. The controller 33 generates a control signal (VCM control signal) fed to the VCM 23 based on the temperature of the hard disk 10 received from the temperature sensor 32.

More specifically, the controller 33 reads, from the storage module 34, notch filter coefficients (described later) corresponding to the temperature of the hard disk 10 received from the temperature sensor 32. The controller 33 creates a notch filter based on the notch filter coefficients. The controller 33 attenuates a specific frequency of the VCM control signal using the notch filter, and inputs the attenuated signal to the VCM 23 through the D/A converter 35. This notch filter creation process will be described in detail later.

The storage module 34 is a nonvolatile storage medium such as ROM, and stores in advance a coefficient table 341. The coefficient table 341 associates each of temperatures at intervals of predetermined degrees with notch filter coefficients of a corresponding notch filter. The temperature defined in the coefficient table 341 is hereinafter referred to as “expected temperature”.

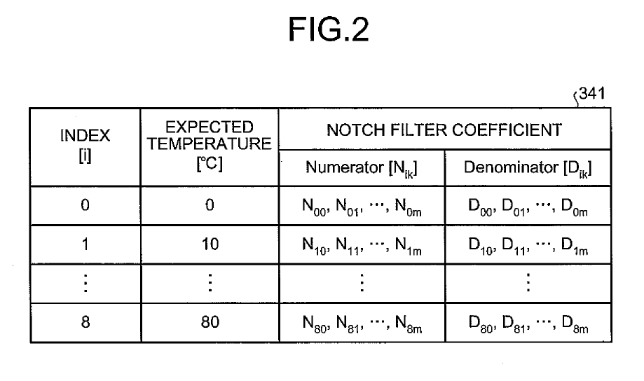

FIG. 2 is an example of the coefficient table 341 stored in the storage module 34. As illustrated in FIG. 2, the coefficient table 341 stores expected temperatures at intervals of 10° C. (0 to 80° C.) each associated with notch filter coefficients (Numerator and Denominator). In the coefficient table 341, “INDEX [i]” indicates information for managing an entry for each expected temperature, and is represented as i=[environmental temperature/R] where R is an interval between the expected temperatures defined in the coefficient table 341. If x=environmental temperature/R, [x] (x: arbitrary real number) is an integer operator and the maximum integer not exceeding “x”. While R=10 in the example of FIG. 2, the interval between the expected temperatures is not limited to this.

Of the notch filter coefficients, “Numerator” indicates the coefficients of the numerator of a transfer function representing a notch filter, while “Denominator” indicates the coefficients of the denominator of the transfer function. If the transfer function H(z) of a notch filter is expressed using the Z function as the following Equation (1), then the coefficients of the numerator “Numerator” are Ni0 to Nim and the coefficients of the denominator “Denominator” are Di0 to Dim.

$$H ( z ) = \frac{{N}_{i 0} {Z}^{- 1} + {N}_{i 1} {Z}^{- 2} + … + {N}_{im} {Z}^{- m}}{{D}_{i 0} {Z}^{- 1} + {D}_{i 1} {Z}^{- 2} + … + {D}_{im} {Z}^{- m}} \qquad ( 1 )$$

where m is the order of the filter. The value of “m” can be arbitrarily set depending on the use.

The notch filter coefficients in the coefficient table 341 are extracted from the numerator and denominator of the notch filter H(z) created according to the resonance mode characteristics of the actuator 20 under the conditions of each expected temperature. Incidentally, it is assumed that the depth of the resonance and the width of the specific frequency attenuated by the notch filter is set to optimal values according to the resonance mode characteristics under the conditions of each expected temperature.

Referring back to FIG. 1, the D/A converter 35 converts the VCM control signal from the controller 33 to an analog signal, and supplies the VCM 23 with a drive current corresponding to the analog signal.

The functional modules of the HDD controller 30 implement the head positioning control system for the magnetic head 21. More specifically, the magnetic head 21 scans the servo sectors 11, thereby obtaining a signal. The A/D converter 31 converts the signal from analog to digital, and outputs it to the controller 33. Meanwhile, the temperature sensor 32 detects the temperature of the hard disk drive device 100 at intervals predetermined at the design time of the hard disk drive device 100, and outputs it to the controller 33 as the environmental temperature. The interval at which the temperature sensor 32 detects the temperature can be arbitrarily set at the design time of the hard disk drive device 100. The controller 33 calculates the head position based on the signal received from the A/D converter 31. The controller 33 also reads, from the storage module 34 (the coefficient table 341), notch filter coefficients corresponding to the environmental temperature detected by the temperature sensor 32, and creates a notch filter based on the notch filter coefficients. In addition, the controller 33 calculates a VCM control signal to be fed to the VCM 23 based on the head position calculated before. The controller 33 then attenuates certain frequency components of the VCM control signal using the notch filter, and outputs the attenuated signal to the D/A converter 35. The D/A converter 35 converts the VCM control signal from digital to analog, and supplies the VCM 23 with a drive current corresponding to the analog signal. With this, the VCM 23 is driven, and thus, according to the VCM control signal, the magnetic head 21 moves in the radial direction of the hard disk 10.

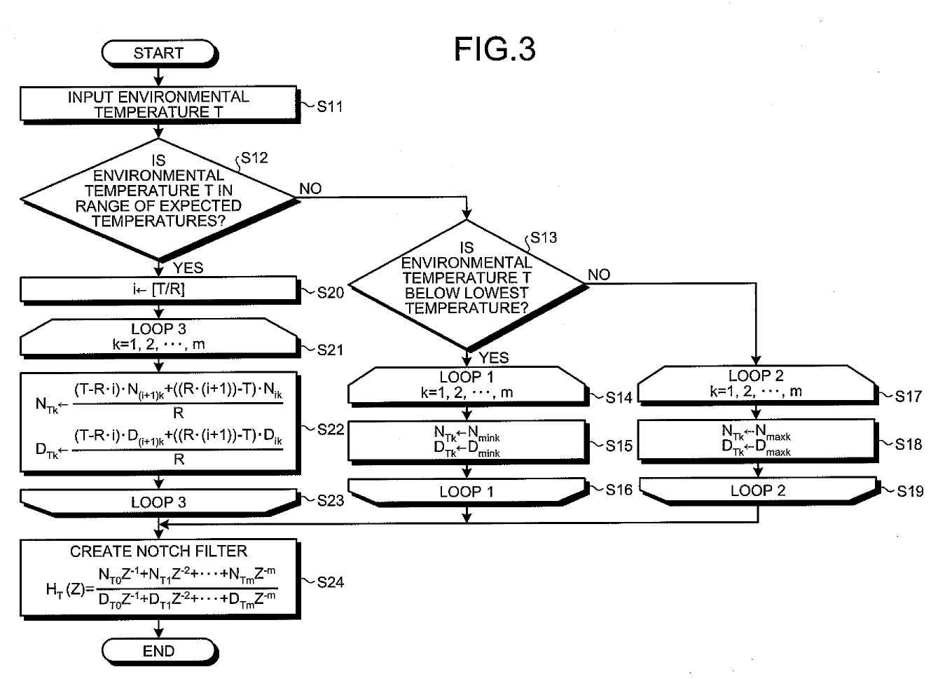

With reference to FIG. 3, a description will be given of the operation of the controller 33 for creating a notch filter (notch filter creation process). In the following description, a notch filter is created based on, for example, the coefficient table 341 of FIG. 2. The controller 33 operates in the same manner with other coefficient tables.

FIG. 3 is a flowchart of the notch filter creation process. The temperature sensor 32 detects the temperature of the hard disk drive device 100 at regular intervals. This temperature is input to the controller 33 as environmental temperature T (S11) The controller 33 determines whether the environmental temperature T is in the range of the expected temperatures from the lowest 0° C. to the highest 80° C. defined in the coefficient table 341 (S12).

When determining that the environmental temperature T is out of the range of the expected temperatures defined in the coefficient table 341 (No at S12), the controller 33 determines whether the environmental temperature T is below the lowest temperature, i.e., 0° C. (S13). When determining that the environmental temperature T is below the lowest temperature (Yes at S13), the controller 33 reads notch filter coefficients associated with the lowest temperature among the expected temperatures defined in the coefficient table 341. The controller 33 then calculates the coefficients of a notch filter for use in the head positioning control by the loop processing from S14 to S16 (LOOP 1).

More specifically, in the loop processing from S14 to S16, with respect to each order k from l to m, the controller 33 substitutes variables N_{Tk} and D_{Tk} with notch filter coefficients Nₘᵢₙₖ and Dₘᵢₙₖ, respectively, which correspond to the lowest temperature among the expected temperatures defined in the coefficient table 341 (S15). The controller 33 repeats the loop processing from S14 to S16 until the order k reaches m. Upon completion of the loop processing, process control moves to S24 Note that Nₘᵢₙₖ and Dₘᵢₙₖ are k-order notch filter coefficients associated with the lowest temperature among the expected temperatures defined in the coefficient table 341.

When determining that the environmental temperature T is above 0° C., i.e., when the environmental temperature T is above the highest temperature 80° C. defined in the coefficient table 341 (No at S13), the controller 33 reads notch filter coefficients associated with the highest temperature among the expected temperatures defined in the coefficient table 341. The controller 33 then calculates the coefficients of a notch filter for use in the head positioning control by the loop processing from S17 to S19 (LOOP 2).

More specifically, in the loop processing from S17 to S19, with respect to each order k from l to m, the controller 33 substitutes variables N_{Tk} and D_{Tk} with notch filter coefficients Nₘₐₓₖ and Dₘₐₓₖ, respectively, which correspond to the highest temperature among the expected temperatures defined in the coefficient table 341 (S18). The controller 33 repeats the loop processing from S17 to S19 until the order k reaches m. Upon completion of the loop processing, process control moves to S24. Note that Nₘₐₓₖ and Dₘₐₓₖ are k-order notch filter coefficients associated with the highest temperature among the expected temperatures defined in the coefficient table 341.

When determining that the environmental temperature T is in the range of the expected temperatures defined in the coefficient table 341 (Yes at S12), the controller 33 substitutes [T/R] for the variable [i] corresponding to “INDEX” in the coefficient table 341 (S20). As described above, [x] (x: arbitrary real number) is an integer operator, and R is an interval between the expected temperatures defined in the coefficient table 341.

Thereafter, the controller 33 reads notch filter coefficients associated with two values of the expected temperatures close to the environmental temperature T in the coefficient table 341, i.e., (R·i)° C. and R(i+1)° C., respectively. The controller 33 then calculates the coefficients of a notch filter for use in the head positioning control by the loop processing from S21 to S23 (LOOP 3).

More specifically, in the loop processing from S21 to S23, with respect to each order k from l to m, the controller 33 reads from the coefficient table 341 notch filter coefficients Nᵢₖ and Dᵢₖ, and N₍ᵢ₊₁₎ₖ and D₍ᵢ₊₁₎ₖ associated with the expected temperatures (R·i)° C. and R(i+1)° C., respectively. The controller 33 then derives, using the following Equations (2) and (3), notch filter coefficients N_{Tk} and D_{Tk} based on a rate corresponding to the difference between the environmental temperature T and (R·i)° C. and R(i+1)° C. (S22)

$$\begin{matrix}{N}_{Tk} = \frac{( T - R \cdot i ) \cdot {N}_{( i + 1 ) k} + ( ( R \cdot ( i + 1 ) ) - T ) \cdot {N}_{ik}}{R} & ( 2 ) \\ {D}_{Tk} = \frac{( T - R \cdot i ) \cdot {D}_{( i + 1 ) k} + ( ( R \cdot ( i + 1 ) ) - T ) \cdot {D}_{ik}}{R} & ( 3 )\end{matrix}$$

Upon completion of the process of S22 for the order k=m, the controller 33 ends the loop processing from S21 to S23, and process control moves to S24.

The controller 33 substitutes the notch filter coefficients N_{Tk} and D_{Tk} derived by the above process into similar Equation (4) to Equation (1) to create a notch filter H_{T}(z) for use in the head positioning control (S24). Thus, the notch filter creation process ends.

$${H}_{T} ( z ) = \frac{{N}_{T 0} {Z}^{- 1} + {N}_{T 1} {Z}^{- 2} + … + {N}_{Tm} {Z}^{- m}}{{D}_{T 0} {Z}^{- 1} + {D}_{T 1} {Z}^{- 2} + … + {D}_{Tm} {Z}^{- m}} \qquad ( 1 )$$

With the notch filter H_{T}(Z) created as above by the notch filter creation process, the controller 33 attenuates certain frequency components of the VCM control signal.

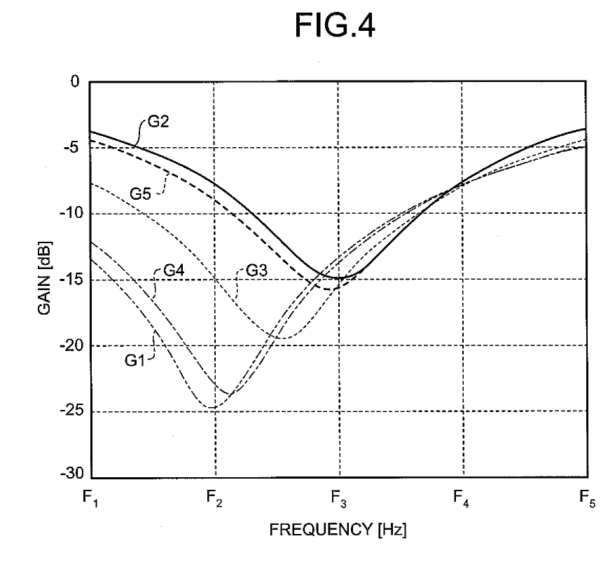

FIG. 4 is a graph of characteristics of the notch filter created by the notch filter creation process. In FIG. 4, the vertical axis represents gain (dB), and the horizontal axis represents frequency (Hz). Curves G1 and G2 represent notch filter characteristics under two adjacent expected temperatures defined in the coefficient table 341.

Curve G1 represents the characteristics of a notch filter H_{T1}(Z) for which the resonance mode of the actuator 20 is optimized under the conditions of expected temperature T1. As can be seen from curve G1, the center frequency in the attenuation band is around F₂ Hz, and the depth of the gain (resonance) is about −25 dB. Curve G2 represents the characteristics of a notch filter H_{T2}(Z) for which the resonance mode of the actuator 20 is optimized under the conditions of expected temperature T2 (T1<T2) As can be seen from curve G2, the center frequency in the attenuation band is around F₃ Hz, and the depth of the gain (resonance) is about −15 dB.

Curves G3 to G5 represent the characteristics of notch filters created based on notch filter coefficients related to curves G1 and G2. Curve G3 represents the characteristics of a notch filter H_{T3} (Z) created by the notch filter creation process under the conditions of environmental temperature T3 of the hard disk drive device 100. Environmental temperature T3 satisfies the following relation: T3=(T1+T2)/2. The notch filter characteristics represented by curve G3 are such that the center frequency in the attenuation band is around (F₂+F₃)/2 Hz, and the depth of the gain (resonance) is about −20 dB. In other words, the notch filter characteristics represented by curve G3 linearly approximates those represented by curves G1 and G2 around environmental temperature T3 according to the value of this environmental temperature T3.

Curve G4 represents the characteristics of a notch filter H_{T4}(Z) created by the notch filter creation process under the conditions of environmental temperature T4 of the hard disk drive device 100. Environmental temperature T4 is slightly above environmental temperature T1 (T1<T4<T3). As with the notch filter characteristics represented by curve G3, the notch filter characteristics represented by curve G4 linearly approximates those represented by curves G1 and G2 around environmental temperature T4 according to the value of this environmental temperature T4. Curve G5 represents the characteristics of a notch filter H_{T5}(Z) created by the notch filter creation process under the conditions of environmental temperature T5 of the hard disk drive device 100. Environmental temperature T5 is slightly below environmental temperature T2 (T3<T5<T2). As with the notch filter characteristics represented by curves G3 and G4, the notch filter characteristics represented by curve G5 linearly approximates those represented by curves G1 and G2 around environmental temperature T5 according to the value of this environmental temperature T5.

As set forth hereinabove, according to an embodiment of the invention, the temperature sensor 32 detects the environmental temperature of the hard disk drive device 100. A notch filter is created based on notch filter coefficients weighted by a rate corresponding to the difference between the environmental temperature and two values of expected temperatures close to the environmental temperature. With this, even if the environmental temperature is between two adjacent expected temperatures, a notch filter can be created that is suitable for the environmental temperature. By applying such a notch filter to a control signal related to the head positioning control for the magnetic head 21, it is possible to improve the accuracy of head positioning according to the environmental temperature.

Moreover, the coefficient table 341 stores notch filter coefficients of a notch filter optimized for each expected temperature. Thus, the storage module 34 requires less storage capacity to store the coefficient table 341.

The various modules of the systems described herein can be implemented as software applications, hardware and/or software modules. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head position control device comprising:
a positioning controller configured to output a control signal indicative of a position to which the head is to be moved to a head moving module configured to move a head for scanning a magnetic disk in a radial direction of the magnetic disk;
a sensor configured to detect an environmental temperature around the magnetic disk; and
a storage module configured to store predetermined temperatures at intervals of predetermined degrees, associated with filter coefficients of a filter configured to attenuate specific frequency components of a control signal corresponding to the predetermined temperatures respectively, wherein
the positioning controller is configured to generate the filter using filter coefficients associated with two predetermined temperatures close to the environmental temperature, and to apply the filter to the control signal, based on a rate of differences between the environmental temperature detected by the sensor and the two predetermined temperatures.

2. The head position control device of claim 1, wherein the positioning controller is configured to generate a filter using a filter coefficient associated with the highest predetermined temperature when the environmental temperature detected by the sensor is above the highest predetermined temperature stored in the storage module.

3. The head position control device of claim 1, wherein the positioning controller is configured to generate a filter using a filter coefficient associated with the lowest predetermined temperature when the environmental temperature detected by the sensor is below the lowest predetermined temperatures stored in the storage module.

4. The head position control device of claim 1, wherein the storage module is configured to store the filter coefficient of the filter, resonance characteristics of the head moving module, and resonance and a center frequency of the specific frequency component being optimized, associated with a corresponding predetermined temperature.

5. A magnetic disk device comprising:
a head configured to read data from and write data to a magnetic disk;
a head moving module configured to move the head in a radial direction of the magnetic disk;
a positioning controller configured to output a control signal to the head moving module in order to position the head at a target location on the magnetic disk;
a sensor configured to detect environmental temperature around the magnetic disk; and
a storage module configured to store predetermined temperatures at intervals of predetermined degrees associated with filter coefficients of a filter configured to attenuate specific frequency components of a control signal corresponding to the predetermined temperatures respectively, wherein
the positioning controller is configured to generate the filter using filter coefficients associated with two predetermined temperatures close to the environmental temperature, and to apply the filter to the control signal, based on a rate of differences between the environmental temperature detected by the sensor and the two predetermined temperatures.

6. The magnetic disk device of claim 5, wherein the positioning controller is configured to generate a filter using a filter coefficient associated with the highest predetermined temperature when the environmental temperature detected by the sensor is above the highest predetermined temperatures stored in the storage module.

7. The magnetic disk device of claim 5, wherein the positioning controller is configured to generate a filter using a filter coefficient associated with the lowest predetermined temperature when the environmental temperature detected by the sensor is below the lowest predetermined temperatures stored in the storage module.

8. The magnetic disk device of claim 5, wherein the storage module is configured to store the filter coefficient of the filter, resonance characteristics of the head moving module, and resonance and a center frequency of the specific frequency component being optimized, associated with a corresponding predetermined temperature.

9. A head position control method applied to a head position control device configured to output a control signal indicating a position to which the head is to be moved to a head moving mechanism that moves a head to scan a magnetic disk in a radial direction of the magnetic disk, the head position control device comprising a storage module configured to store predetermined temperatures at intervals of predetermined degrees, associated with filter coefficients of a filter configured to attenuate specific frequency components of a control signal corresponding to the predetermined temperatures, the method comprising:
detecting environmental temperature around the magnetic disk; and
generating a filter using filter coefficients associated with two predetermined temperatures close to the environmental temperature in order to apply the filter to the control signal, based on a rate of differences between the environmental temperature detected at the detecting and the two predetermined temperatures.
